(19) United States
(12) Patent Application Publication
(10) Pub. No.: US 2024/0356451 A1
(43) Pub. Date: Oct. 24, 2024

(54) Bidirectional Voltage Adapter

(71) Applicant: Current Ways, Inc., Santee, CA (US)

(72) Inventors: Claude Michael Kalev, Newbury Park, CA (US); Robert Rosen, Agoura Hills, CA (US)

(21) Appl. No.: 18/137,745

(22) Filed: Apr. 21, 2023

(51) Int. Cl. H02M 3/335; H02M 1/00

(52) U.S. Cl. CPC H02M 3/33584; H02M 1/0025; H02M 3/33571

(57) ABSTRACT

A bidirectional voltage adapter incorporates a planar transformer, an active bridge, and a DC dual active bridge.

### BACKGROUND OF THE INVENTION

### Field of Invention

The present invention relates to an article of manufacture. In particular, a bidirectional voltage adapter using a planar transformer is disclosed.

### Discussion of the Related Art

High frequency power conversion systems are of interest in academia and industry for high power density, reduced weight, and low noise, hopefully without compromising performance, cost, and reliability. Recent use of dual active bridges and use of planar transformers in such systems presents challenges, many of which lack efficient and robust solutions.

### SUMMARY OF THE INVENTION

A bidirectional voltage adapter comprises an active front end, a DC dual active bridge, and a planar transformer.

In an embodiment, a bidirectional voltage adapter comprises: an AC link connecting a bidirectional AC power connection and an active front end that includes a bidirectional inverter; a DC link connecting a bidirectional DC power connection and a DC dual active bridge; the active front end and the DC dual active bridge connected by a bridge link; a planar transformer within the DC dual active bridge connects a primary bridge and a secondary bridge; and, an inductor within the DC dual active bridge connects one of the primary and secondary bridges with the planar transformer.

In an embodiment the bidirectional voltage adapter includes: circuit boards bearing windings within a ferrite E core of the planar transformer; halves of the E core pressed together by metal plates to either side of the E core; and the circuit boards pressed together by the E core halves and metal plates to either side of the E core.

### BRIEF DESCRIPTION OF THE DRAWINGS

The present invention is described with reference to the accompanying figures. These figures, incorporated herein and forming part of the specification, illustrate the present invention and, together with the description, further serve to explain the principles of the invention and to enable a person skilled in the relevant art to make and use the invention.

FIG. 1A shows a bidirectional voltage adapter of the present invention.

FIGS. 1B-C show bidirectional voltage adapters in accordance with FIG. 1A.

FIGS. 2A-D show a circuit diagram of a particular bidirectional voltage adapter in accordance with FIG. 1A.

FIGS. 2E-F show schematics of a first planar transformer for use in the bidirectional voltage adapter of FIG. 1A.

FIGS. 3A-E show embodiments of a second planar transformer for use in the bidirectional voltage adapter of FIG. 1A.

FIGS. 4A-F show a circuit board and included windings for use in a planar transformer of the bidirectional voltage adapter of FIG. 1A.

FIGS. 5A-B show circuit board winding layer connections, the circuit board for use in a planar transformer of the bidirectional voltage adapter of FIG. 1A.

FIGS. 6A-C show embodiments of a third planar transformer for use in the bidirectional voltage adapter of FIG. 1A.

### DETAILED DESCRIPTION OF THE PREFERRED EMBODIMENTS

The disclosure provided in the following pages describes examples of some embodiments of the invention. The designs, figures, and descriptions are non-limiting examples of certain embodiments of the invention. For example, other embodiments of the disclosed device may or may not include the features described herein. Moreover, disclosed advantages and benefits may apply to only certain embodiments of the invention and should not be used to limit the disclosed inventions.

As used herein, the term “coupled” includes direct and indirect connections. Moreover, where first and second devices are coupled, interposed devices including active devices may be located therebetween.

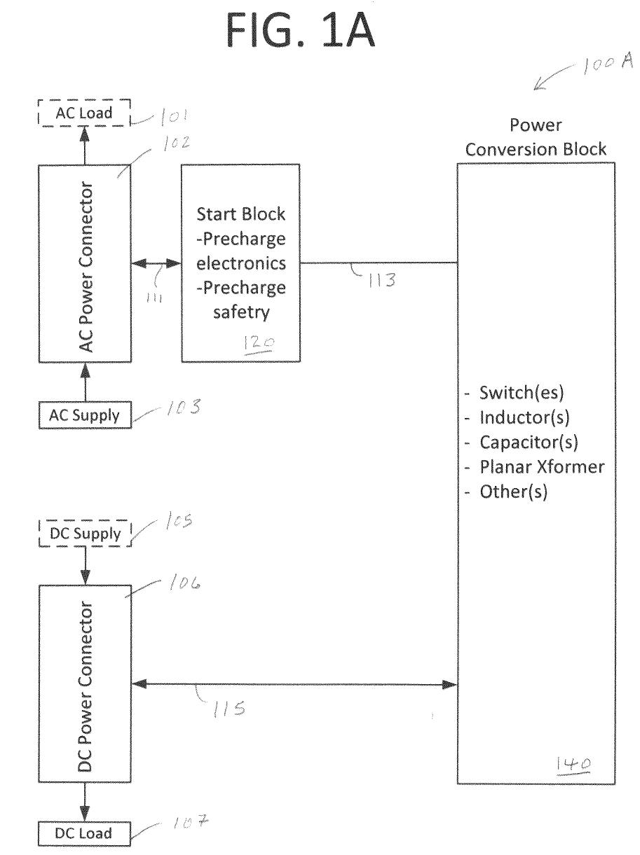

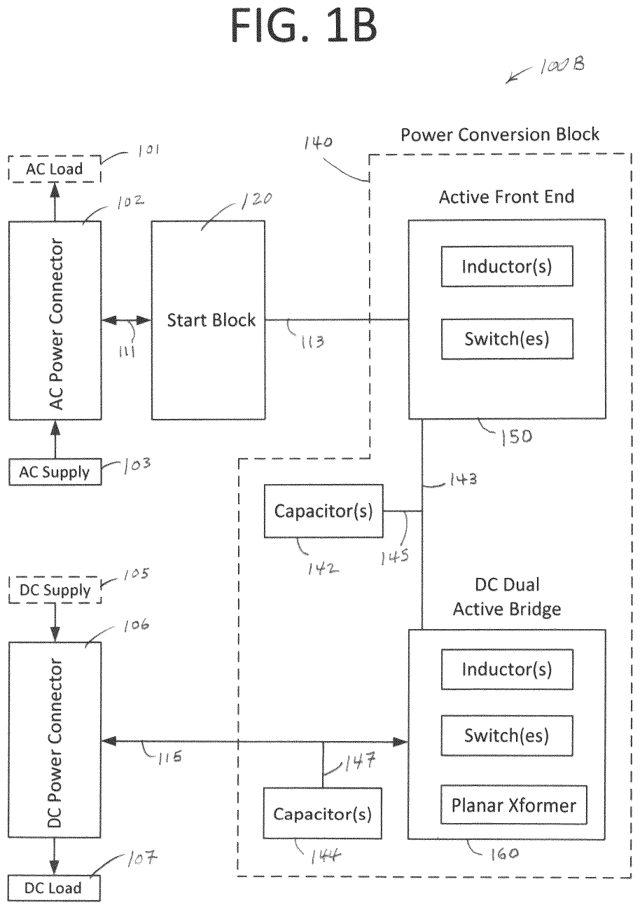

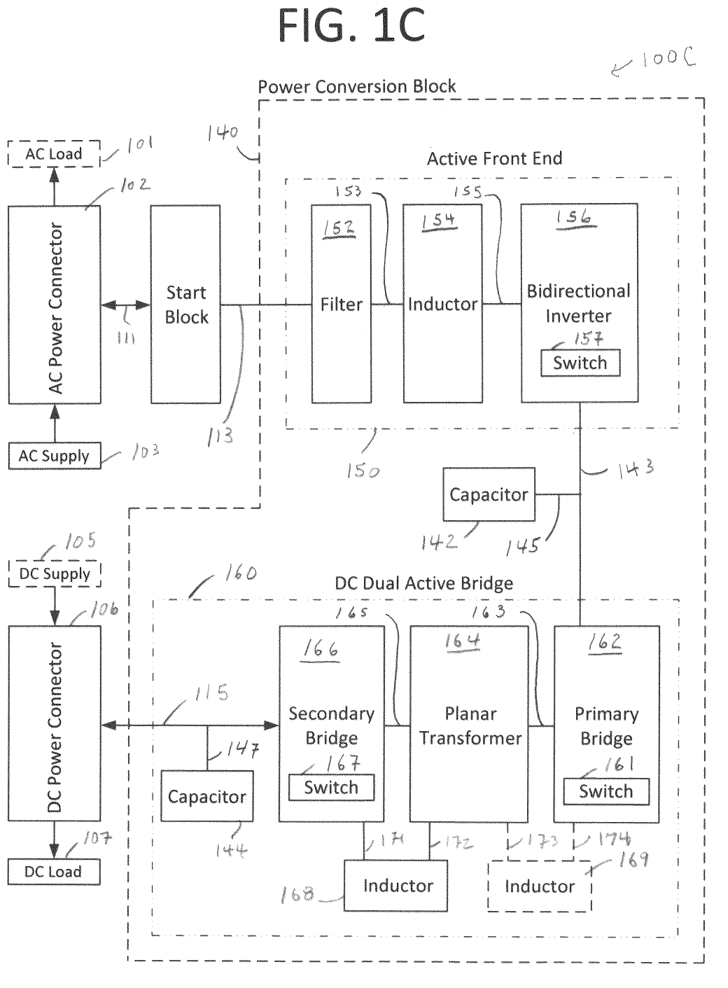

FIG. 1A shows a block diagram of a bidirectional voltage adapter 100A. As shown, power connections such as AC and DC power connections 102, 106 connect with a power conversion block 140 including any one or more of planar transformer(s), switch(es), inductor(s), capacitor(s), and other electrical component(s). AC and DC power supplies 103, 107 interconnect with the AC and DC power connectors. AC and DC loads 101, 105 interconnect with AC and DC power connectors. A start block 120 may be interposed between power connection 102 and the power conversion block 140. As shown, the start block 120 connects with the AC power connection 102 and the power conversion block 140 via paths 111 and 113 while the DC power connection 106 connects with the power conversion block via path 115. Note that any of lines, connections, interconnections, and paths may utilize one or more electrical conductors unless otherwise noted.

FIG. 1B shows a block diagram of a bidirectional voltage adapter with a second power conversion block 100B. The power conversion block 140 includes an active front end 150 and a DC dual active bridge (“DAB”) 160. The active front end includes inductor(s) and switch(es). The dual active bridge includes inductor(s) and switch(es). Path 111 connects the AC power connector 102 and the start block 120, path 113 connects the active front end and start block 120, path 115 connects the DC power connector 106 with the DC dual active bridge, and path 143 connects the active front end and the DC dual active bridge. Path 145 connects a capacitor 142 and path 143. Path 147 connects a capacitor 144 and path 115.

FIG. 1C shows a block diagram of a bidirectional voltage adapter 100C with a third power conversion block. The power conversion block 140 includes an active front end 150 and a DC dual active bridge 160.

The active front end includes filter 152 that is connected by path 153 to an inductor 154 that is connected by path 155 to a bidirectional inverter 156 which includes switch 157. The active front end is connected to the DC dual active bridge 160 by path 143 extending between the bidirectional inverter and primary bridge 162. Capacitor 142 is connected to the path 143 via path 145.

The dual active bridge includes a primary bridge 162 and switch 161. The primary bridge is connected 163 with a planar transformer 164 that is connected 165 with a secondary bridge 166 and switch 167. The secondary bridge is connected by path 115 with the DC power connector 106. A capacitor 144 is connected to path 115 via path 147.

In one embodiment, an inductor 168 connects with the secondary bridge 166 and the planar transformer 164 via paths 171, 172. In an alternate embodiment, an inductor 169 connects with the planar transformer and the primary bridge 162 via paths 173, 174.

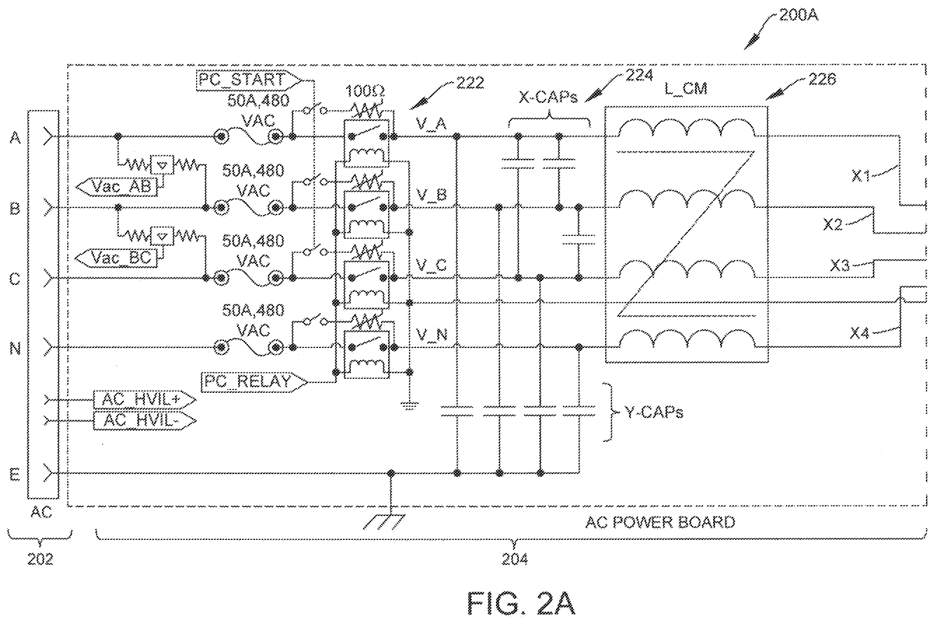

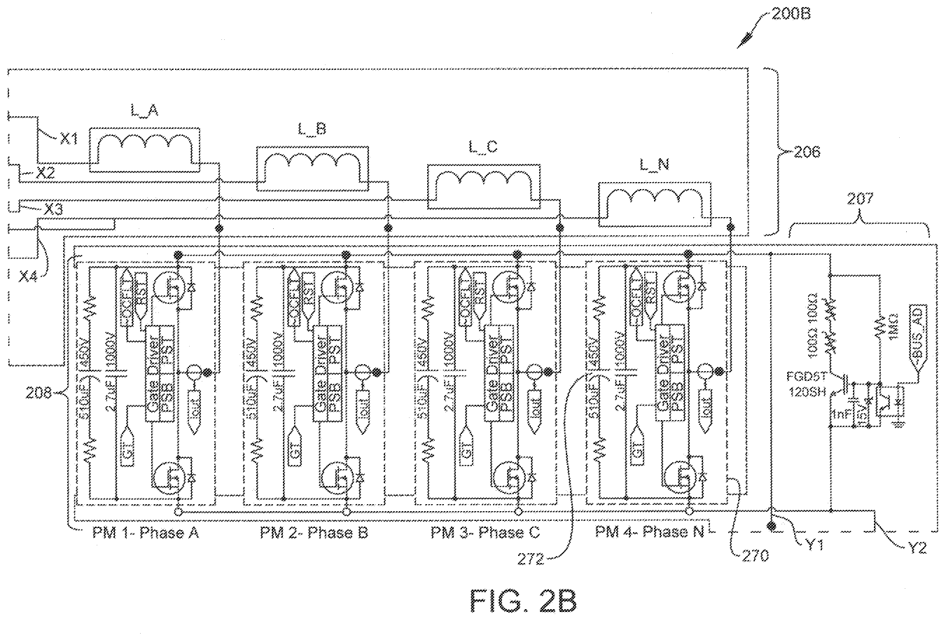

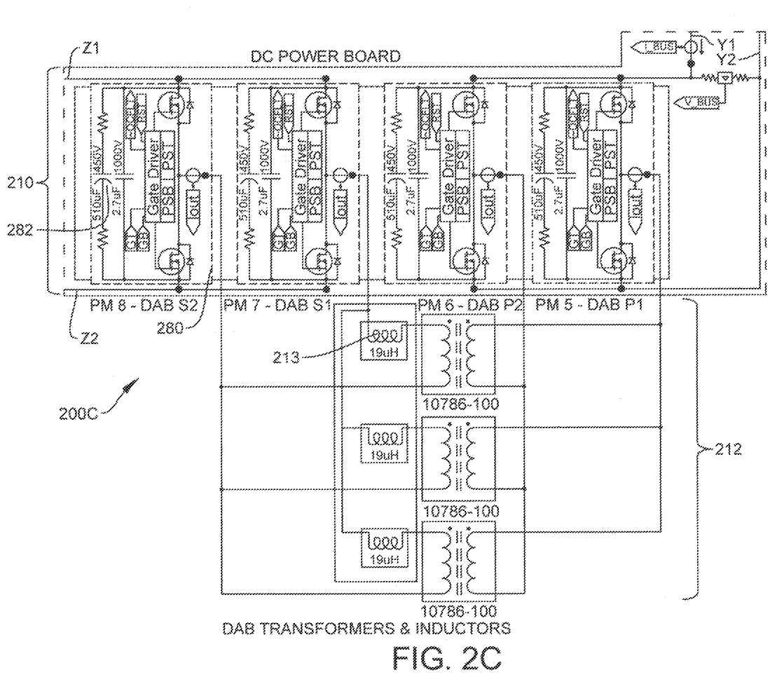

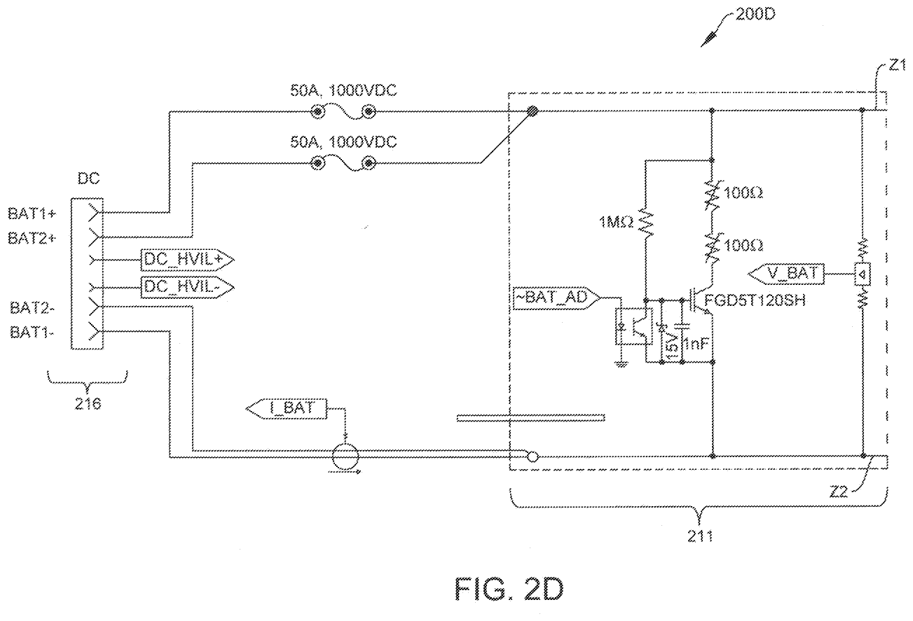

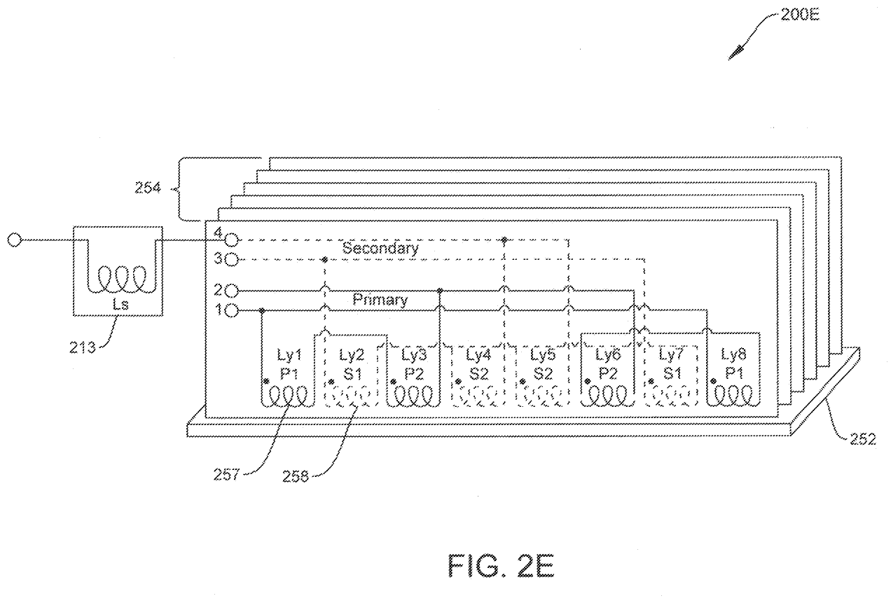

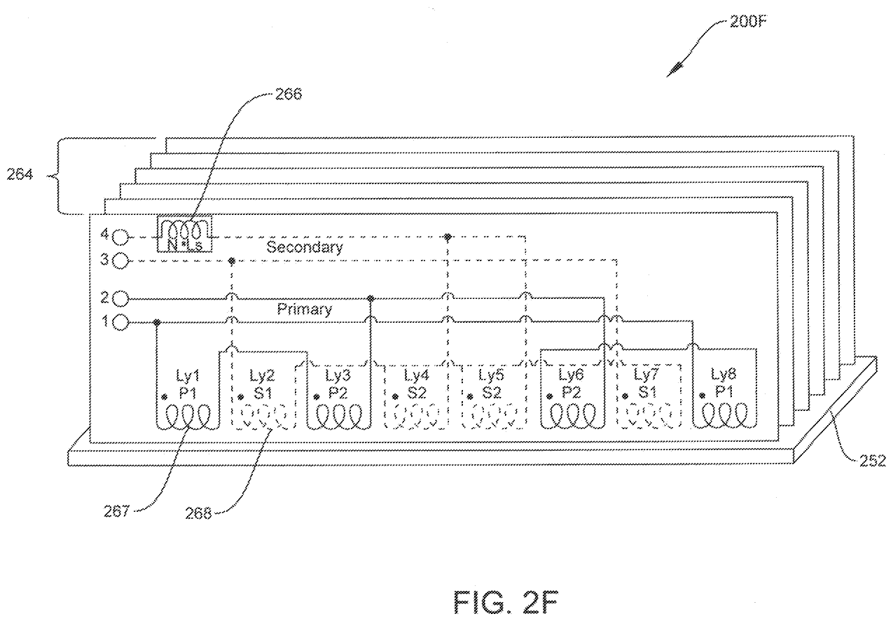

FIGS. 2A-D show a circuit diagram of a bidirectional voltage adapter 200A-D. These four diagrams are interconnected as shown at connections (X1, X2, X3, X4), (Y1, Y2), and (Z1, Z2).

FIG. 2A shows a start circuit 204 with an AC power connector 202, contactors 222, filters 224, and a common mode inductor 226. FIG. 2B shows inductors 206 for energy storage associated with voltage boosting and an active front end 208. Circuit 207 provides a safety feature including active discharge of the electrolytic capacitors 272 included in each of four half bridge modules 270 included in the active front end. FIG. 2C shows four half bridge modules 280, 210 each having an electrolytic capacitor 282. Interconnected with the four half bridge modules are three planar transformers 212 with external inductors 213. FIG. 2D shows a DC power connector 216 interconnected with circuit 211 that provides a safety feature including active discharge of the electrolytic capacitors 282 (see FIG. 2C).

FIGS. 2E and 2F show planar transformer schematics 200E-F including external inductor 213 of FIG. 2C. In FIG. 2E, a transformer ferrite core 252 couples flux associated with four primary 257 and four secondary windings 258 (8 layer circuit board, Ly1-Ly8) on each of six circuit boards 254. As shown, the single inductor 213 is separated from the transformer (see e.g. FIG. 2C) and interconnects with transformer secondary winding layers 4 and 5 of each board. The core may be a ferrite core or another suitable core. The core may be an E core or another suitable core.

In FIG. 2F, a transformer ferrite core 252 couples flux associated with four primary 267 and four secondary windings 268 (8 layer circuit board, Ly1-Ly8) on each of six circuit boards 264. In this arrangement, there is an inductor 266 located on each of the six circuit boards. As shown, on each board the inductor interconnects with secondary windings at layers 4 and 5.

### Planar Transformer

The planar transformers used in the bidirectional voltage adapters above require at least windings and a core. Windings may be provided by conductors and the core may be provided by a ferrite structure suited for confining and guiding a magnetic field created when a current passes through the windings. One such structure is a planar transformer including one or more circuit boards bearing windings and a ferrite core. A portion of the ferrite core is encircled by the windings.

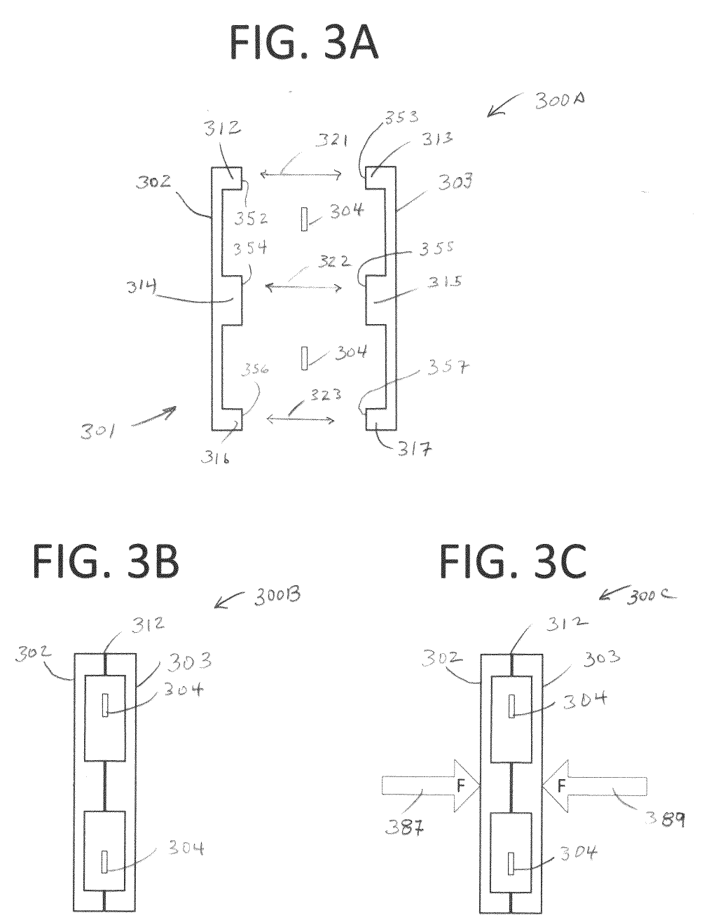

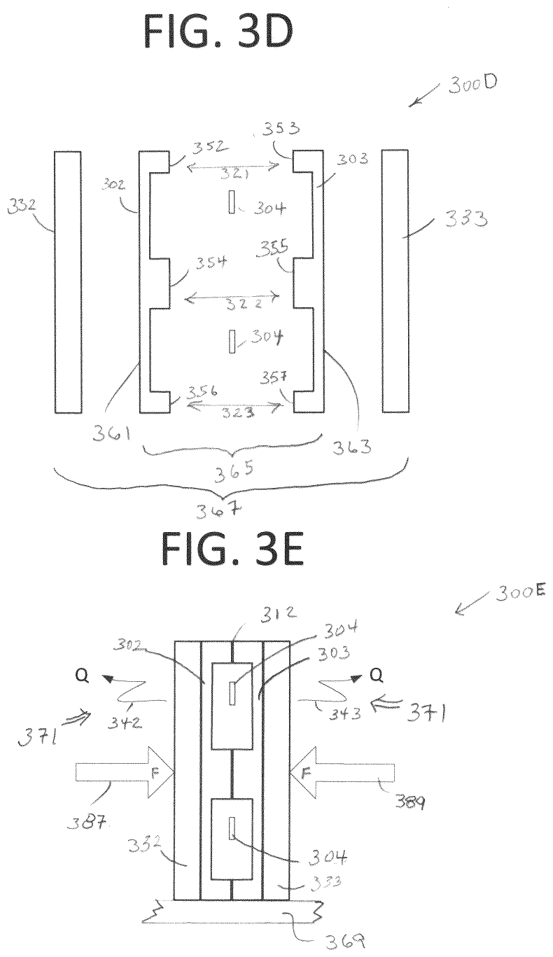

FIG. 3A shows an exploded cross-sectional view of a planar transformer 300A including a ferrite core 301 with “E” shaped halves 302, 303. A conductor or winding 304 is for encircling a central ferrite core leg (314, 315). As shown in this exploded view, gaps 321, 322, 323 exist between a) core legs 312, 313 with meeting surfaces 352, 353, b) core legs 314, 315 with meeting surfaces 354, 355, and c) core legs 316, 317 with meeting surfaces 356, 357.

FIG. 3B shows an assembled cross-sectional view of the planar transformer 300B. Here, the core halves 302, 303 are brought together such that the gaps 321, 322, 323 are ideally closed at centerline 312. In practice, air gaps may remain even when the core halves are brought together. These air gaps are due, for example, to imperfect meeting surfaces, thermal effects occurring during transformer operation, and other conditions.

### Reduced Transformer Air Gaps

Minimizing and/or controlling the air gaps 321, 322, 323 of the assembled transformer reduces transformer losses by, among other things, minimizing the magnetic flux fringes around the edges of the gaps.

FIG. 3C shows the planar transformer 300C with opposing forces “F” (387, 389) applied to force the core halves 302, 303 together such that a pressure applied to each core half reduces the air gaps 321, 322, 323. If transformer dimensional changes are neglected, for example by neglecting coefficients of thermal expansion of transformer materials, a simple vice-like clamp applying F accomplishes this purpose. However the “vise” clamp may apply too little or too much force if the transformer expands or contracts with temperature excursions. Too little force may result in the air gaps opening. And because ferrite cores are fragile and do not tolerate severe point loads or unevenly distributed loads, too much force may crack or crush the ferrite.

FIG. 3D is an exploded cross-sectional view of the planar transformer with load spreaders 300D. The transformer 365 is between load spreading plates 332, 333, together 367, such that the core halves 302, 303 can be pushed together. As shown, transformer core halves 302, 303 are for capturing a winding 304 and the core halves are between load spreading plates 332 and 333. The load spreaders may be included in a cage, for example a cage enclosing or partially enclosing the core halves, for holding the core halves together.

FIG. 3E shows an assembled cross-sectional view of the planar transformer with load spreaders 300E. Equal and opposite forces 387, 389 are applied to the spreader plates such that the core halves 302, 303 meet at centerline 312, the air gaps 321, 322, 323 being reduced by application of the forces. Spreader plates may be good conductors of heat 342, 343 such that transformer heat can be dissipated.

### Enhanced Transformer Heat Transfer

Forces 387, 389 applied to the spreader plates 332, 333 reduce point loads on the ferrite core 302, 303. However, these spreader plates cover the sides 361, 363 of transformer 365 and impede cooling during transformer operation. Solutions that cool a transformer with load spreaders covering portions of the transformer include enhancing conduction and/or convection heat transfer.

Conduction heat transfer may be enhanced, for example, by increasing the thermal conductivity of the load spreaders 332, 333 and cooling a base plate 369 on which the transformer is mounted. In various embodiments, the spreaders are made from a material with a high thermal conductivity such as a conductivity equal to or better than that of aluminum (the thermal conductivity of aluminum and its alloys, which is 88 to 251 W/m K, or 51 to 164 Btu/(h ft F) which is several times the value for steels). In various embodiments, a transformer base plate or mounting plate is cooled with a flowing working fluid. In some embodiments, the working fluid flows in tubes such as copper tubes. In some embodiments, a surface of the tube or flat surface of the tube contacts the transformer directly or via an interposed layer of thermal grease/material to enhance contact.

Convection may be enhanced, for example, by moving cooling air 371 (see FIG. 3E) over surfaces of the transformer assembly 300E. In various embodiments, fan(s) and/or features involving transformer shape/orientation may be used to enhance convection heat transfer.

### Transformer Windings on Circuit Boards

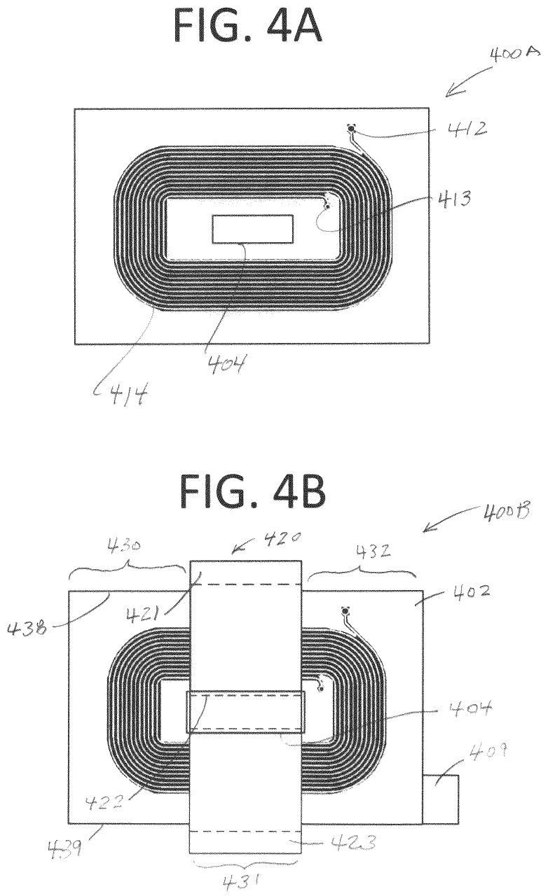

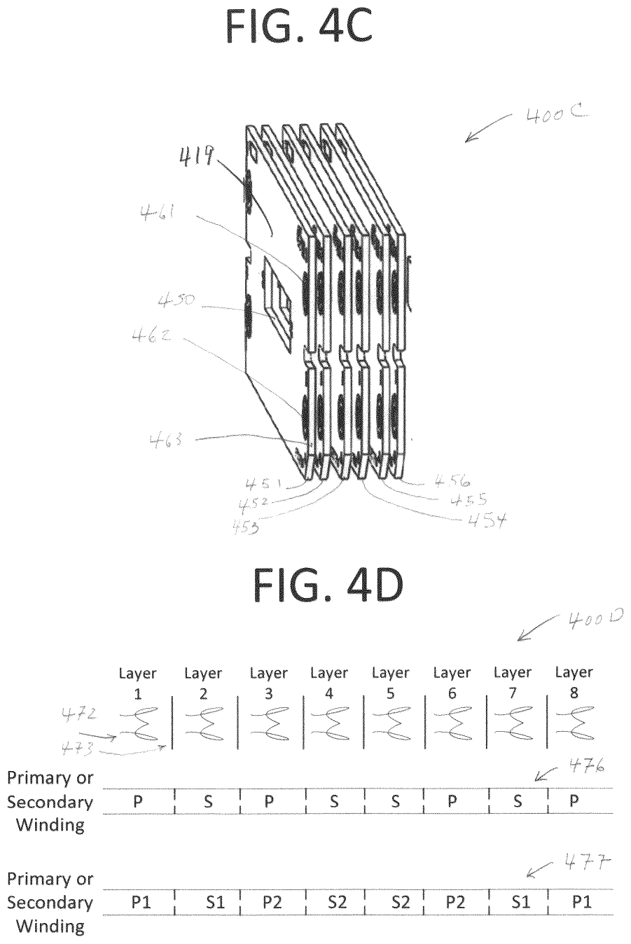

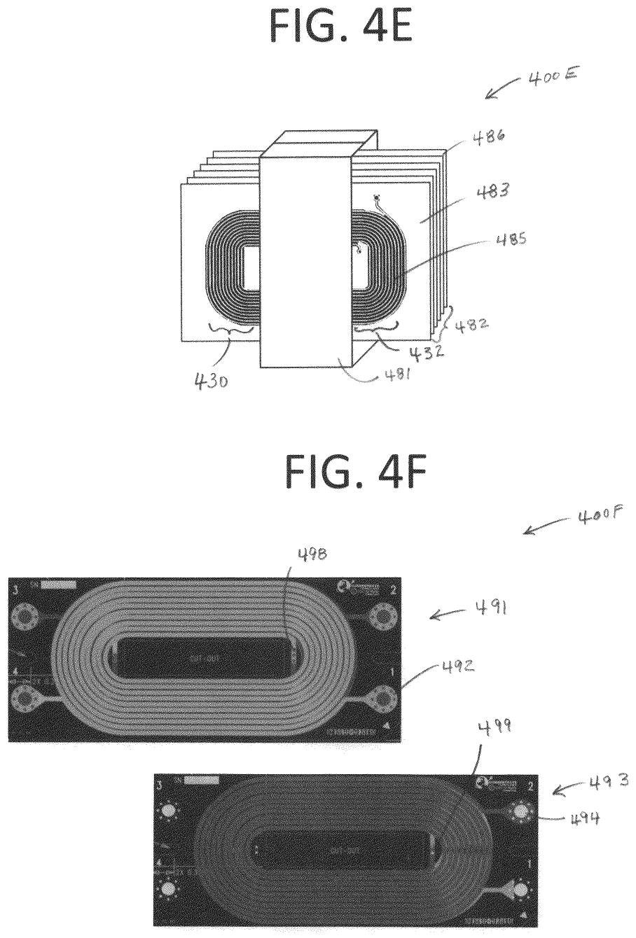

FIG. 4A shows a printed circuit board or layer of a printed circuit board with a transformer winding 400A. In particular, a board 402 bears a winding 414 and winding connections 412, 413. A hole or center hole 404 in the circuit board is for receiving a center leg 314, 315 of a ferrite core. In various embodiments the printed circuit board may be two sided with a winding on each side. In various embodiments, the board may be a multi-layer board such as an 8 layer board with 8 somewhat superposed windings. Windings may be primary windings or secondary windings. Primary windings may be connected in parallel. Secondary windings may be connected in parallel.

FIG. 4B shows the circuit board installed in a core such as a ferrite core 400B. In particular, a printed circuit board 402 is captured or partially captured within an “E” core 420 having legs 421, 422, 423. As seen, the center leg of the E core 422 passes through the circuit board hole 404 while core outer legs 421, 423 wrap around edges 438, 439 of the circuit board. Here, the E core covers a central portion of the printed circuit board 431 while ends of the printed circuit board including the winding end-turn regions 430, 432 are not covered by the E core.

FIG. 4C shows a group of circuit boards 400C for installation in a transformer core. Similar to the circuit board of FIGS. 4A-B, these boards 451-456 have central holes 450 to accept a leg of an E core such that the boards are adjacent to each other. The boards may be multi-layer having, for example, a winding on each side and internal windings (not shown). For each board the windings terminate at connections such as connections 461, 462. One connection may be near a board/layer end 463 and a second connection may be near the board or layer center 419. In various embodiments, different numbers of circuit boards may be used in constructing a planar transformer. In an embodiment a group of circuit boards includes multiple printed circuit boards, each board having multiple layers and a winding at multiple layers.

### Controlling Transformer Leakage Inductance

Transformer leakage inductance is influenced by the geometry of the core and the windings. This leakage inductance is an inductive component resulting from imperfect magnetic linking between windings. Multi-layer circuit boards with a winding at each layer provide a means of limiting leakage inductance. For example, a primary winding layer facing a secondary winding layer may enhance primary to secondary coupling and may result in lower transformer leakage inductance.

FIG. 4D shows an eight layer circuit board with windings distributed at each layer 400D. Board construction includes windings 472 and separators such as insulating material between the layers or windings 473. Here, the circuit board includes distributed windings where primary windings are as shown 476 at layers 1, 3, 6, 8 and secondary windings are as shown 476 at layers 2, 4, 5, 7. This board winding arrangement reduces AC resistance and improves primary to secondary coupling as compared, for example, to a similar board with primary windings at layers 1, 2, 3, 4 and secondary windings at layers 5, 6, 7, 8.

Referring again to FIG. 2C, in some embodiments, a primary winding lead or secondary winding lead of the transformer 212 connects with an external inductor 213 that is not influenced by the core of the transformer.

In some embodiments, inductance is distributed through the transformer by placing an inductor on a tab extension (266 of FIG. 2F, 409 of FIG. 4B) on each circuit board included in a group of circuit boards such as a small inductor on each circuit board in a group of circuit boards 400C. Two inductors may be placed on a single tab, one on each side of the extension tab. The tabs of each such board may be laterally displaced from each other to allow room for inductor placement. To benefit cooling, the total surface area of the distributed inductor may be larger than for a single inductor with the same total inductance.

### Limiting Transformer Loss

Transformer losses may be limited or minimized by maximizing winding/conductor 412 cross-sections or thickness and interleaving 476, 477 primary windings with secondary windings. Among other things, this can minimize AC resistance while allowing for proper connection of the windings of each of multiple circuit board layers.

In an embodiment, a planar transformer utilizes a group of multiple or six circuit boards which may be identical or similar circuit boards and each circuit board includes multiple or eight layers. A winding which may be a copper trace is located at each layer. Within the transformer, the group of circuit boards may be pressed together or adjacently located. Further, winding interconnections 412, 413 for selected layers may be connected in parallel.

FIG. 4E shows an embodiment of a planar transformer core and its group of circuit boards bearing windings 400E. Here, there are multiple or in cases six circuit boards 482 which may be substantially identical. Each circuit board includes multiple or in cases 8 layers and a winding 485 is located at each layer. The circuit boards are partially enclosed in a magnetic core 481 with the end-turns 430, 432 of the windings 485 being outside the core.

Here, there may be four types of layers or windings (see item 477 of FIG. 4D).
1. P1, primary inward spiral
2. P2, primary outward spiral
3. S1, secondary inward spiral
4. S2, secondary outward spiral

FIG. 4F shows these inward and outward winding configurations 400F. Exemplary spiral windings are shown 491, 493. The exemplary inward spiral 491 begins at a peripheral connection 492 and ends at central via (circuit board “via”) 498. The exemplary outward spiral 493 begins at central via 499 and ends at peripheral connection 494.

Layers within the multi-layer circuit board 483 (see FIG. 4E) are insulated from each other but it is difficult to achieve good insulation at the interface 486 where one board faces another without wasting valuable space within the core. The palindromic winding sequence described herein with each board in parallel may allow for uninsulated or poorly insulated contact between boards.

In some embodiments, the order chosen for windings in an eight layer board is a palindromic sequence P1, S1, P2, S2, S2, P2, S1, P1 as shown in item 477 of FIG. 4D (numeral 1 indicates inward spiral while numeral 2 indicates outward spiral). In this sequence, the primary and secondary windings are highly interleaved which reduces the proximity effect and with it the AC resistance. As a consequence, thick copper traces can be used effectively to reduce losses and heating caused by losses. For example, the AC resistance factor at 100 kHz was found to be only a few percent (modeled via FEA and measured) with about 40% copper utilization of the core or ferrite cavity volume. Another advantage of this sequence is the low cross capacitance losses (adjacent P1 to S2 or P2 to S1).

### Circuit Board Layers

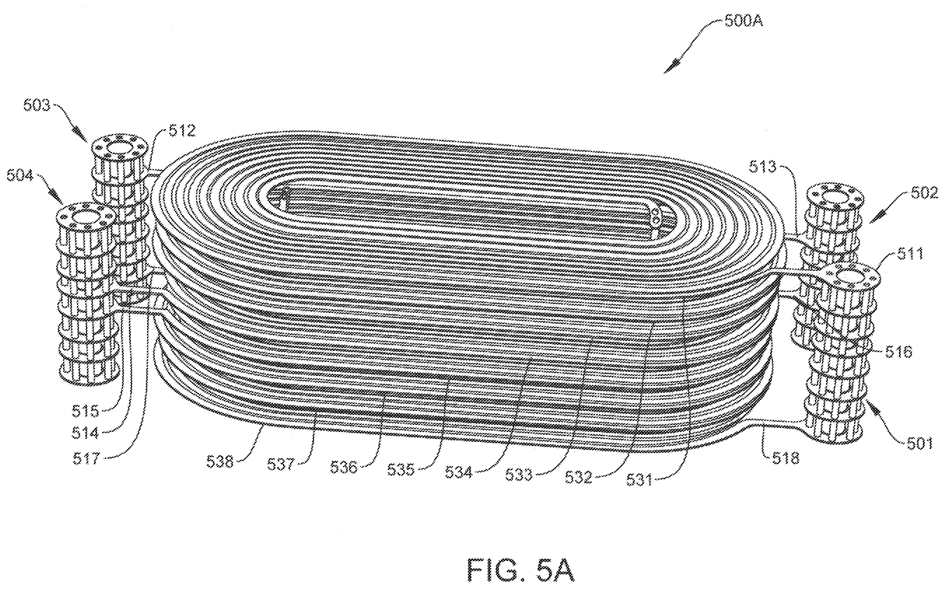

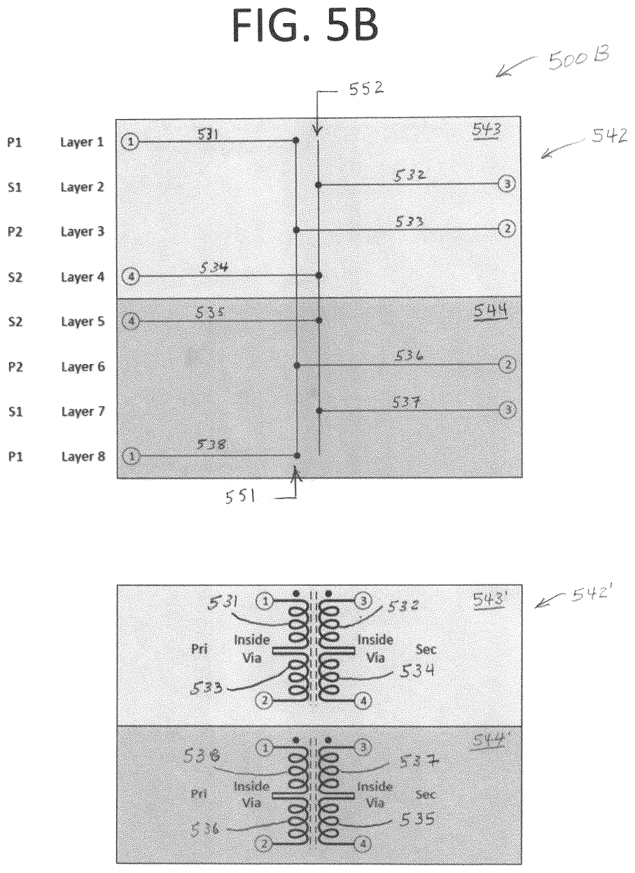

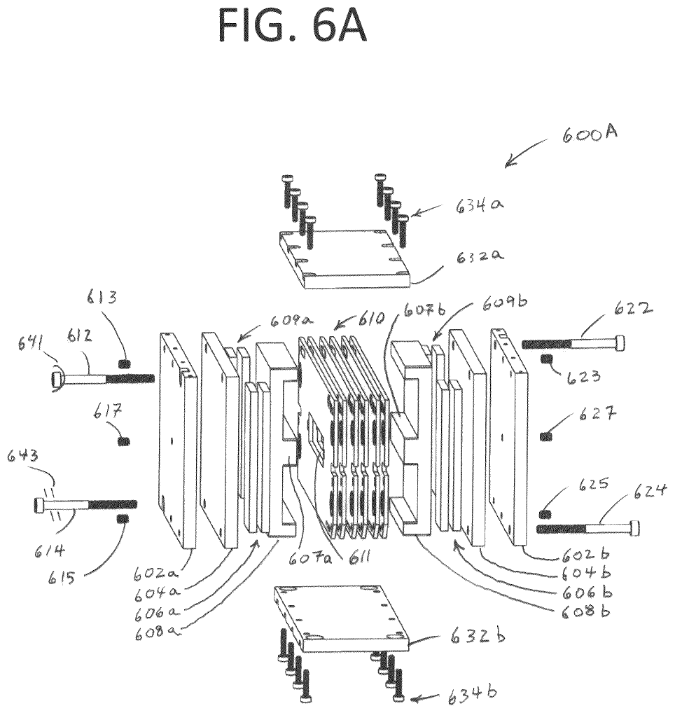

In an embodiment, the circuit boards 482 of a planar transformer have eight layers with a winding in each layer. Some embodiments incorporate the winding interconnections of FIGS. 5A and 5B.

FIG. 5A shows eight windings in eight layers for incorporation in a circuit board 500A. The eight windings 531-538 interconnect at four posts 501-504 which may extend through the group of boards 482 within the core 481. The first post 501 interconnects 518 with winding 538 and 511 with winding 531. The second post 502 interconnects 516 with winding 536 and 513 with winding 533. The third post 503 interconnects 517 with winding 537 and 512 with winding 532. The fourth post 504 interconnects 515 with winding 535 and 514 with winding 534.

FIG. 5B shows first and second schematics 500B of the connections of FIG. 5A. These connections are connections among the central vias of the circuit boards. The schematic 542 shows via interconnections 551, 552. At interconnections 551, windings 531, 534, 535, 538 are interconnected. At interconnections 552, windings 532, 533, 536, 537 are interconnected. The circled numbers refer to the posts of FIG. 500A as follows: 1/501, 2/502, 3/503, 4/504.

The second schematic 542′ shows a first set of windings 543′ and a second set of windings 544′. The first set 543′ shows a realization of the interconnections 543 in FIG. 5A. The second set 544′ shows a realization of the interconnections 544 in FIG. 5A. When these two sets are connected in parallel, a realization of the circuits of the first schematic 542 results.

### Encased Planar Transformer

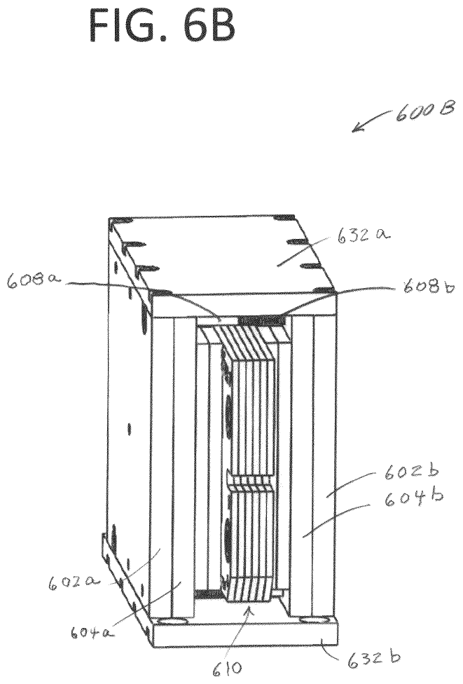

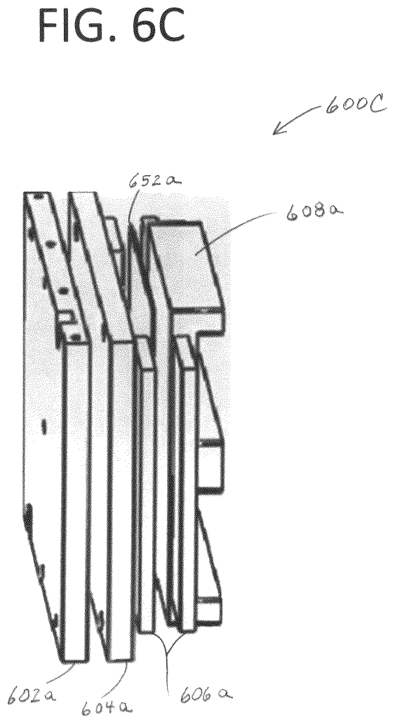

FIG. 6A shows an exploded view of an encased planar transformer assembly 600A and FIG. 6B shows an assembled view of the encased planar transformer assembly 600B. This transformer's features, including ones similar to those in the figures above, are embodied in its electromagnetic/magnetic parts and in its encasement/ancillary parts.

### Transformer Electromagnetic and Magnetic Parts

Electromagnetic and magnetic parts of the transformer include a group of circuit boards bearing windings 610 sandwiched within an E core 608a-b. The E core is made from a material characterized by relatively low conductivity, low eddy current, low dielectric losses, low hysteresis, and high permeability. A central leg 607a-b of the E core passes through circuit board windings via holes in the circuit boards 611.

### Encasement/Ancillary Parts, Core Pressure Management

The encasement parts include core pressure management parts tending to press the core halves 608a-b together. This pressure may result from forces including forces tending to elongate fasteners 612, 614, 622 and 624. As seen, an open-ended box is formed by outermost plates at the sides 602a-b, top 632a, and bottom 632b. Fasteners 634a and 634b that attach the top, bottom and sides may provide a rigid structure. Within this structure, E core halves 608a-b are pressed together by intermediate plates 604a-b when set screws 613, 615, 617 bearing on/urging the left intermediate plate 604a are screwed into the left side plate 602a and when set screws 623, 625, 627 bearing on/urging the right intermediate plate 604b are screwed into the right side plate 602b. In addition to providing pressure on the core halves 608a-b, the plates 602a-b, 604a-b are designed to provide a highly conductive thermal path from the core and to perhaps a lesser extent from the circuit boards 610. The intermediate parts may be included in a cage for holding the core halves together. The cage may include any of the intermediate plates, the outer plates, and the bolts 612, 614, 622, 624.

### Encasement/Ancillary Parts, Circuit Board Pressure Management

The encasement parts include circuit board pressure management parts tending to press the circuit boards 610 together. This pressure may result from forces including forces tending to elongate fasteners 612, 614, 622 and 624. As seen, an open-ended box is formed by outermost plates at the sides 602a-b, top 632a, and bottom 632b. Fasteners 634a and 634b that attach the top, bottom, and sides may provide a rigid structure. In some embodiments, the structure may not affect the pressure of the plates against the core. Within this structure, the circuit boards captured between left thermal pads 606a, 609a (e.g., resilient conductors of heat such as Henkel's Bergquist thermal management materials, including GAP PAD® gap fillers, SIL PAD® thermal interface products) and right thermal pads 606b, 609b are pressed together by intermediate plates 604a-b when set screws 613, 615, 617 bearing on/urging the left intermediate plate 604a are screwed into the left side plate 602a and when set screws 623, 625, 627 bearing on/urging the right intermediate plate 604b are screwed into the right side plate 602b. Heat from the group of circuit boards 610 is thereby conducted through the thermal pads to intermediate plates 604a-b. In addition, resilient thermal pads (not shown) may be located to either side of the circuit board group 610 and the adjacent core halves 608a, 608b. Note that it may usually be the case that forces required to develop pressures that hold the core halves together are larger or much larger (2X to 10X and larger) than forces required to develop pressures that hold the circuit boards together.

### Force and Pressure Management Techniques

Planar transformers may experience wide temperature operating ranges, for example operation at temperatures of −40 deg C. to 150 deg C. Here, it may not be possible to neglect the expansions and contractions of materials incorporated in a planar transformer assembly and the consequent impact on structures attempting to maintain somewhat constant forces and pressures holding the core halves 608a-b together.

A technique that accommodates or reduces the effects of these expansions and contractions uses the coefficients of thermal expansion of various materials to maintain a somewhat constant force holding parts together. Another technique involves the use of spring or spring-like devices that exhibit a somewhat constant force for a particular range of movement, elongation or displacement. For example, any of the bolts 612, 614, 622, 624 may be tensioned by springs 643 or by Belleville washers 641. For example, fasteners or fixtures which pressure the core halves may be biased by springs 643 or by Belleville washers 641. Any one or more of these techniques or both of these techniques may be employed.

### Force and Pressure Management Utilizing Coefficients of Expansion

As mentioned, the first technique relies on various coefficients of thermal expansion. Select, for example, materials where bolts or fasteners holding the structure together have length changes equal or about equal to the length changes of the combined components held together by the bolts.

Consider a stack including a central core with left and right magnetic core halves sandwiched between plates to either side, for example core 608a-b and intermediate plates 604a-b. The stack is held together by stretched bolts, for example fasteners 612, 614, 622, 624, where Young's Modulus determines forces resulting from bolt elongation. The result is equal and opposite pressures exerted at an interface between the core halves. A suitable pressure or pressure range will tend to minimize transformer air gap losses. For example, a suitable pressure or pressure range may be maintained such that it tends to maximize an inductance attributable at least in part to the core without exceeding the compressive or crush strength of the core halves. This pressure or range of core interface pressures may be thought of as the pressure that closes the core, i.e. core closure pressures.

Having described the stack and a desirable range of core closure pressures, consider now the effects of varying temperature on core closure pressures. For example, when temperature rises, the length of the entire stack tends to increase as the plates 604a-b and core halves 608a-b expand against the constraining forces exerted on the stack by the stretched bolt 612, 614, 622, 624. If the bolts expand less than the stack, the core closure pressure increases. If the bolts expand more than the stack, the core closure pressure decreases. If the bolts expand equally with the stack, the core closure pressure remains constant.

Maintenance of a particular core closure pressure or core pressure range may consider coefficients of thermal expansion (CTE), stretched bolt length (LB), compressed core length (LC) and compressed plate length (LP). Take for example a core with a single plate to either side of the core 608a-b such that the stack includes the core and the two plates 604a-b.

To demonstrate the technique, the simplified model below indicates parameter approximations matching bolt length changes with stack length changes to maintain a constant core closure pressure.

$$CTEB \times LB = CTELeft Plate \times LLeft Plate + CTEC \times LC + CTERight Plate \times LRight Plate$$

Where: CTEB is the bolt CTE
   CTEC is the core CTE
   LLeft Plate is a Length/thickness of the Left Plate
   LRight Plate is a Length/thickness of the Right Plate

Neglecting, among other things, forces arising from circuit board pressures, this or similar models can be used to match stack and bolt length changes that involve various materials and various components including various numbers of plates. As skilled artisans will appreciate, more precise models may consider among other things, different planar transformer structures, additional forces, and temperature distribution. As skilled artisans will appreciate, more precise analysis using, for example, a finite element model, may be used.

In the present case, when a transformer similar to that of FIG. 6A is modeled as above, pressures on ferrite core halves 608a-b may be maintained in an acceptable range for transformer operating temperatures of −40 deg C.-150 deg C. when stainless steel fasteners 612, 614, 622, 624 are used with aluminum or aluminum alloy intermediate plates 604a, 604b. In an exemplary embodiment, a MnZn ferrite is used, a 300 series stainless steel is used and a 2000 series aluminum alloy is used.

### Force and Pressure Management Techniques Using Spring-Like Devices

As described above, springs that exert a constant or somewhat constant force over a range of displacements (e.g., extensions or contractions) may be used to control the force and resulting pressure holding the core halves 608a-b together during transformer temperature excursions. For example, springs may be used to pull and/or push transformer assembly parts such as the intermediate plates 604a-b and/or the outer plates 602a-b together. For example, Belleville washers 641 around fasteners 612, 614, 622, 624 may be used. For example, springs around fasteners 612, 614, 622, 624 may be used. The spring devices and the managed thermal expansion may be used together to relax the required accuracy of the CTE matching and the range of displacement of the spring.

FIG. 6C shows yet another force and pressure management technique that uses thermal pads or resilient thermal pads 600C. Here, a pad 652a is shown between core half 608a and intermediate plate 604a. A similar pad, not shown, is between core half 608b and intermediate plate 604b. These pads act like springs and like the spring devices mentioned above serve to hold the core halves 608a-b together during transformer temperature excursions. In addition, they may enhance heat transfer from the core 608a-b.

### Heat Transfer Management Techniques

As described above, the intermediate 604a-b and outer 602a-b plates, such as aluminum plates, conduct heat away from transformer parts including the core halves 608a-b. The top and bottom plates 632a-b may also serve as conductors of heat away from the core halves. And as described above, a heat transfer fluid in a transformer base plate or tube within a transformer base plate may serve as a conductor of heat away from the bottom plate 632b.

In addition, thermal pads 606a-b contact the circuit board group 610 and the intermediate plates 604a-b to conduct heat away from transformer parts including the circuit boards. Further, thermal pads conducting heat away from the circuit board group 610 (not shown) may be located to either side of the circuit board group 610 and the adjacent core halves 608a, 608b.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A bidirectional voltage adapter comprising:
an AC link connecting a bidirectional AC power connection and an active front end that includes a bidirectional inverter;
a DC link connecting a bidirectional DC power connection and a DC dual active bridge;
the active front end and the DC dual active bridge connected by a bridge link;
a planar transformer within the DC dual active bridge connects a primary bridge and a secondary bridge; and,
an inductor within the DC dual active bridge connects one of the primary and secondary bridges with the planar transformer.

2. The bidirectional voltage adapter of claim 1 further comprising:
circuit boards bearing windings within a ferrite E core of the planar transformer; and,
halves of the E core pressed together by metal plates to either side of the E core.

3. The bidirectional voltage adapter of claim 2 wherein the circuit boards are pressed together by the metal plates to either side of the E core.

4. The bidirectional voltage adapter of claim 1 further comprising:
circuit boards of the planar transformer, the circuit boards bearing windings;
mating E core portions of the planar transformer, the circuit boards between the E core portions;
the E core portions between intermediate plates; and,
the intermediate plates applying pressure tending to force the E core portions together.

5. The bidirectional voltage adapter of claim 4 further comprising:
adjacent end-turn regions of the circuit boards that lie outside the E core; and,
the end-turn regions pressed together by the intermediate plates.

6. The bidirectional voltage adapter of claim 4 further comprising:
outer plates arranged such that the intermediate plates are between the outer plates;
screws in the outer plates that bear on the intermediate plates; and,
an intermediate plate pressure arises from bolts stretched by forces tending to bring the outer plates together.

7. The bidirectional voltage adapter of claim 6 further comprising:
a range of adjustment of intermediate plate pressure that depends upon a projection of one or more of the outer plate screws.

8. The bidirectional voltage adapter of claim 6 wherein intermediate plate pressure is made less sensitive to temperature variations by choosing a bolt material having a coefficient of thermal expansion such that bolt length changes are similar to length changes of parts held together by the bolts.

9. The bidirectional voltage adapter of claim 8 wherein the bolts are made from stainless steel or a stainless steel alloy and the intermediate plates are made from aluminum or an aluminum alloy.

8. The bidirectional voltage adapter of claim 7 wherein an intermediate plate pressure is selected that tends to maximize a planar transformer inductance without damaging the E core.

9. The bidirectional voltage adapter of claim 4 wherein one of the circuit boards includes eight layers, a winding being located at each layer.

10. The bidirectional voltage adapter of claim 9 wherein the eight windings of the circuit board are interconnected such that four of the windings form a first set of windings and the other four of the windings form a second set of windings, the sets of windings being connected in parallel.

11. The bidirectional voltage adapter of claim 9 wherein a winding sequence is P, S, P, S, S, P, S, P where P indicates a primary winding and S indicates a secondary winding.

12. The bidirectional voltage adapter of claim 11 wherein the windings are ordered in a palindromic sequence P1, S1, P2, S2, S2, P2, S1, P1 where 1 indicates an inward spiral winding and 2 indicates an outward spiral winding.

13. A method of isolating a power supply from a load in a bidirectional voltage adapter, the method comprising the steps of:
providing a power conversion block between an AC power connector and a DC power connector, the power conversion block including an active front end coupled to a DC dual active bridge;
in the DC dual active bridge, connecting a primary bridge to a planar transformer; and,
in the DC dual active bridge, connecting a secondary bridge to the planar transformer.

14. The method of claim 13 further including the step of:
providing a transformer core and circuit boards within the core;
wherein the core includes mating parts and air gaps between the mating parts, the air gaps being reduced by a cage that applies pressure that holds the mating parts together.

15. The method of claim 14 wherein the cage includes bolts, bolt tension being increased to increase the pressure holding the mating parts together.

16. The method of claim 15 wherein planar transformer electrical operation is optimized by tensioning the bolts such that a planar transformer inductance is maximized without damaging transformer parts.

17. The method of claim 16 further including the step of cooling an end turn of a circuit board via one or more members providing a heat conduction path between the circuit board and the cage.

18. The method of claim 17 wherein the circuit boards include an eight layer circuit board with a winding at each layer.

19. The method of claim 18 wherein four of the eight windings form a first transformer and the other four of the eight windings form a second transformer, the transformers being interconnected in parallel.

20. The method of claim 19 wherein a winding sequence for the eight winding layers is P, S, P, S, S, P, S, P where P indicates a primary winding and S indicates a secondary winding.
